(19) United States
(12) Patent Application Publication
(10) Pub. No.: US 2017/0177077 A1
(43) Pub. Date: Jun. 22, 2017

(54) THREE-DIMENSION INTERACTIVE SYSTEM AND METHOD FOR VIRTUAL REALITY

(71) Applicant: National Taiwan University, Taipei (TW)

(72) Inventors: Chao-Chung Yang, Taipei (TW); Shih-Chung Kang, Taipei (TW)

(73) Assignee: National Taiwan University, Taipei (TW)

(21) Appl. No.: 15/374,911

(22) Filed: Dec. 9, 2016

Related U.S. Application Data
(60) Provisional application No. 62/265,299, filed on Dec. 9, 2015.

(51) Int. Cl. G06F 3/01

(52) U.S. Cl. CPC G06F 3/013; G06F 3/017

(57) ABSTRACT

The present invention relates to a rear screen three-dimension interactive system for a virtual reality. The rear screen three-dimension interactive system for a virtual reality includes a computing device; a display device electrically connected with the computing device, facing toward a user, and showing a three-dimension image for an article to the user; an image sensor electrically connected with the computing device, situated at a front side in front of the display device, keeping a second distance from the display device, and sensing a vision movement made by the user who is situated in the front side; and a motion sensor electrically connected with the computing device, situated at a rear side in back of the display device, keeping a first distance from the display device, and sensing a hand based action made by the user in the rear side.

This application claims benefit of U.S. Provisional Patent Application No. 62/265,299, filed on Dec. 9, 2015, in the United State Patent and Trademark Office, the disclosure of which is incorporated herein its entirety by reference. The patent or application file contains at least one drawing executed in color. Copies of this patent or patent application publication with color drawing(s) will be provided by the Office upon request and payment of the necessary fee.

### FIELD

The present invention relates to a three-dimension interactive system and method applied in a virtual reality, in particular, to a rear screen three-dimension interactive system and method involved in the kinesthetic vision for a virtual reality.

### BACKGROUND

A design review (DR) is a critical control point throughout the product development process to evaluate whether the design is against its requirements. To ensure to meet these requirements reliably, the DR is the process of redesign iteratively between design and review teams. The review team is responsible for checking and critiquing the design repeatedly until the requirements are all fulfilled.

During the process, the production of prototypes is a key-factor to examine how far requirements are met. As the booming of computer-aided design (CAD) and virtual reality (VR) technologies, digital prototyping (DP) or digital mock-Up (DMU), the probably problems of design can be pre-identified, which efficiently shortens a life cycle of product development in early phases of products. The competitive advantage of DP is advancement the decision from physical prototypes which are relatively time-consuming and cost-demanding. For example, building information model (BIM) is a virtual mock-up of a building project in AEC industries, used to demonstrate the design to the stakeholders. Reviewers can preview space aesthetics and layout in a virtual environment.

The prior art claims the three prerequisites of DP are CAD, simulation and VR. Simulation and CAD-data provide quantifiable results, whereas the VR techniques evaluate the above results qualitatively. Within the 3D environment supported by VR, user have the opportunity to understand designs in greater detail, combining with advanced display devices and novel input devices.

Since the first commercial 2D mouse device was sold in the marketplace in 1983, it has become the most dominant computer pointing device. It allows fine control of two-dimensional motion, which is appropriate for common uses with a graphical user interface. However, the issue of how to extend the use of mouse for 3D graphics is still unexplored. Virtual Controllers are discussed and evaluated commonly in the previous studies.

On the other hand, the limitation of degree of freedom (DoF) still makes it ineffective for higher degree of manipulation, including panning, moving, rotating, etc. To break through the above restriction, controllers with three or more DoF are developed for enhancing the usability. Zhai surveyed previous 3D input devices and considered the multiple aspects of usability. However, the widespread availability and user habituation still lead to the dominant position of mouse device. Previous researchers compared the performance efficiency between 2D mouse device and other three high DoF input devices for 3D placement task, and the former outperform in this case.

Natural User Interface (NUI) refers to the human-machine interface that is effectively invisible. Steve Mann uses the word “Natural” to refer to an interactive method that comes naturally to users, and the use of nature itself and the natural environment. NUI is also known as “Metaphor-Free Computing”, which exclude processes of metaphor for interacting with computers. For instance, in-air gestural control allows users to navigation in a virtual environment by detecting body movements without translating movements form physical controller to motions in the virtual world.

Many researchers make great efforts to develop hands gesture input devices for fine and natural 3D articles manipulation. Zimmerman, etc. developed a glove with analog flex, ultrasonic or magnetic flux sensors providing real-time gesture information. On the other hand, vision-based gesture recognition techniques are also flourishing due to its advantage of non-contact control. The IR-vision motion sensing techniques further improve the accuracy with extra depth sensors and are also commercialized. For example, Kinect is an IR-based gesture sensing device for full-body motion and Leap Motion focuses on hand gesture with fine motion control.

Indeed, above research and products improve the shortcomings of lack of DoF and the intuitive from traditional input devices. However, the discontinuities between virtual and real environment still remain some obstacles of articles manipulating in the virtuality.

Eye-hand coordination refers to the coordinated control between eyes and hands motions. The visual input from eyes provides spatial information of targets previously before hands movements. For virtual navigations, spatial information, however, are not coincident with manipulation space. Users often manipulate articles in front of displays, whereas articles are actually in back of displays. Coupling between these two spaces is inevitable, but also raise the challenge in the eye-hand coordination.

There is a need to solve the above deficiencies/issues.

### SUMMARY

The present invention proposes an intuition interaction by a simple rear-screen physical setup. In this invention, it intends to prove that adding kinesthetic sense on the basis of sight enhance the eye-hand coordination and make better depth perception in design review processes.

In the virtual environment, virtual simulated hands are constructed and in the same dimension and position with real hands in the rear of screen. With this approach, users are like to enter their hand into the virtuality and interactive directly with virtual articles. The articles in the virtuality are modeled in the correct dimension by referencing the scale between the virtual eyes coordinate and the real eyes coordinate.

The present invention proposes a three-dimension interactive system for a virtual reality. The system includes a computing device; a display device electrically connected with the computing device, facing toward a user, and showing a three-dimension image for an article to the user; an image sensor electrically connected with the computing device, situated at a front side in front of the display device, keeping a second distance from the display device, and sensing a vision movement made by the user who is situated in the front side; and a motion sensor electrically connected with the computing device, situated at a rear side in back of the display device, keeping a first distance from the display device, and sensing a hand based action made by the user in the rear side.

Preferably, the system further includes a vision movement marker configured on the user for the image sensor to detect for sensing the vision movement from the user.

Preferably, the user watches the three-dimension image and makes the hand based action and the vision movement in reaction to the article in accordance with the three-dimension image.

Preferably, the motion sensor senses the hand based action and sends to the computing device, the image sensor senses the vision movement and sends to the computing device, and the computing device instantly adjust the three-dimension image in accordance with the hand based action and the vision movement, whereby the user is able to experience an interaction with the article virtually.

The present invention further proposes a three-dimension interactive system for a virtual reality. The system includes a computing device; a display device electrically connected with the computing device, facing toward a user, and showing a three-dimension image for an article to the user; and a motion sensor electrically connected with the computing device, situated at a rear side in back of the display device, keeping a first distance from the display device, sensing a hand based action made by the user in the rear side, and sending the hand based action to the computing device, wherein the user makes the hand based action in reaction to the article virtually situated in back of the display device in accordance with the three-dimension image and the computing device instantly adjusts the three-dimension image in accordance with the hand based action.

Preferably, the system further includes an image sensor electrically connected with the computing device, situated at a front side in front of the display device, keeping a second distance from the display device, sensing a vision movement made by the user who is situated in the front side, and sending the vision movement to the computing device.

The present invention further proposes a three-dimension interactive method for a virtual reality. The method includes showing a three-dimension image for an article in a virtual reality to a user by a display device, wherein the three-dimension image virtually simulates a three-dimension status for the article which the article is virtually situated at a rear side in back of the display device, and the user perceives the article in the virtual reality through the three-dimension image; making a hand based action by the user in a rear side in back of the display device; sensing the hand based action from the rear side; and adjusting the three-dimension image in accordance with the sensed hand based action.

Preferably, the method further includes making a vision movement by the user in a front side in front of the display device; sensing the vision movement from the front side; and adjusting the three-dimension image in accordance with the sensed hand based action and vision movement.

Preferably, the user makes the hand based action and the vision movement in reaction to the article in accordance with the three-dimension image, and the three-dimension image is instantly adjusted in accordance with the hand based action and the vision movement, whereby the user is able to experience an interaction with the article virtually.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating a rear screen three-dimension interactive system in accordance with the present invention;

FIG. 2 is a schematic diagram illustrating an operating scenario for the rear screen three-dimension interactive system in accordance with the present invention;

FIGS. 3(a) and 3(b) are images illustrating the actual operating scenario for the three-dimension interactive system in accordance with the present invention;

FIG. 4 is a schematic diagram illustrating a rear screen three-dimension kinesthetic interactive system in accordance with the present invention;

FIGS. 5(a)-5(c) are schematic diagrams illustrating a space coupling relationship used in the kinesthetic interactive system in accordance with the present invention;

FIG. 6 is a diagram illustrating a geometric relationship between a frustum and a near plane for building a kinesthetic vision in the virtual reality in accordance with the present invention; and

FIG. 7 shows a flow chart for implementing the above rear screen three-dimension kinesthetic interactive method for a virtual reality in accordance with the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “comprising” or “including”, used in the claims and specification, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

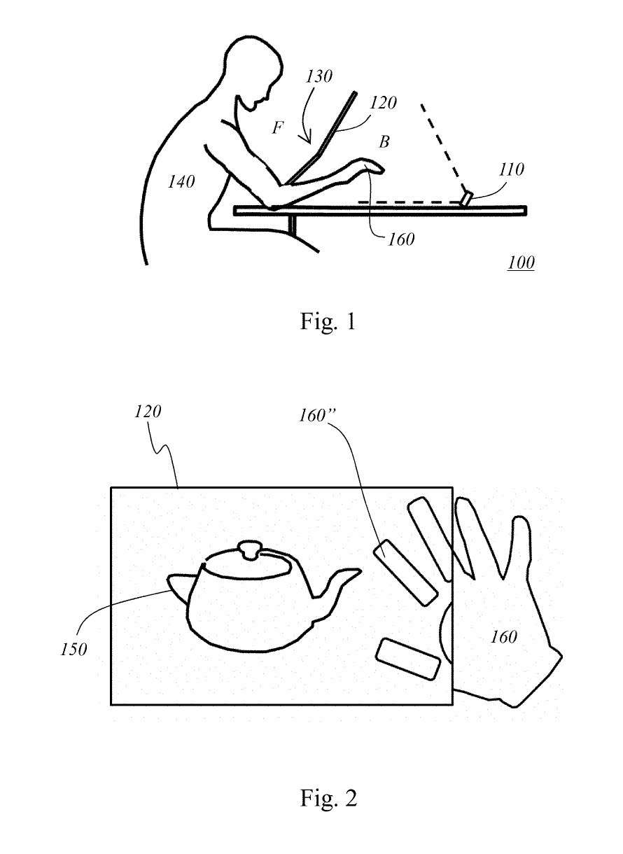

FIG. 1 is a schematic diagram illustrating a rear screen three-dimension interactive system in accordance with the present invention. As shown in FIG. 1, the rear screen three-dimension interactive system 100 in accordance with the present invention includes a motion sensor 110, a portable computing device 130 with a screen 120. A user 140 is situated in a front side F in front of the screen 120. The user 140 can operate the portable computing device 130 by observing the displayed contents in the screen 120.

The motion sensor 110 is situated in a rear side R in back of the screen 120 and keeps a first distance from the screen 120. The motion sensor 110 is a sensor capable of sensing, detecting, tracing or recording actions, motions or traces from human's fingers, hands or gestures. The information the motion sensor 110 detected is sent to the portable computing device 130 as inputs. A motion controller produced by Leap Motion, Inc. is adopted as the motion sensor 110.

FIG. 2 is a schematic diagram illustrating an operating scenario for the rear screen three-dimension interactive system in accordance with the present invention. The above-mentioned rear screen three-dimension interactive system 100 is straightforwardly applied to virtual reality technology, so as to build an interactive environment in real time between the virtual reality and the user. As shown in FIG. 2, a simple virtual reality is shown in the screen 120. There is a virtual three-dimension teapot 150 shown in the virtual reality. Typically the contents shown in the screen 120 is to virtually show or simulate a virtual environment in back of or behind the screen 120. The teapot 150 shown in the screen 120 is virtually situated in back of or behind the screen 120. The system 100 allows a user to move hands entering into the virtual reality to virtually play, rotate, touch, move and take the teapot 150.

All the user 140 currently needs to do is to follow the scenario shown on the screen 120, to slowly move hands, such as, a right hand, into the rear side R behind the screen 120, to touch or to catch the teapot 150 which appears to be put at the rear side R behind the screen 120. When the hand 160 of the user 140 enters into the scope of the screen 120, the motion sensor 110 correspondingly detects this hand based action and the computing device 130 immediately shows a virtual hand 160″ on the screen 120. Basically the virtual hand 160″ has a size in proportion or scale with respect to the real hand 160 and comprehensively, instantly and correspondingly simulates the location, the posture and the gesture from the real hand 160. The user 140 is able to adjust the real hand 160 according to the virtual hand 160″. The user 140 can keep adjusting and moving the real hand 160 until the real hand 160 touches the teapot 150.

The above virtual hand 160″ is built in the virtual reality environment and correspondingly built in proportion and scale with respect to the real hand 160 in the size, the location, the posture and the gesture, which the real hand 160 is currently situated behind the screen 120. By such way, the user 140 is almost able to feel like stretching the real hand 160 into the virtual reality shown in the screen 120, to have a straight interaction with the virtual article the teapot 150. All The articles in the virtual reality are virtually simulated with correct three-dimension perspective scale which is corresponding to the real hand 160 in the real world.

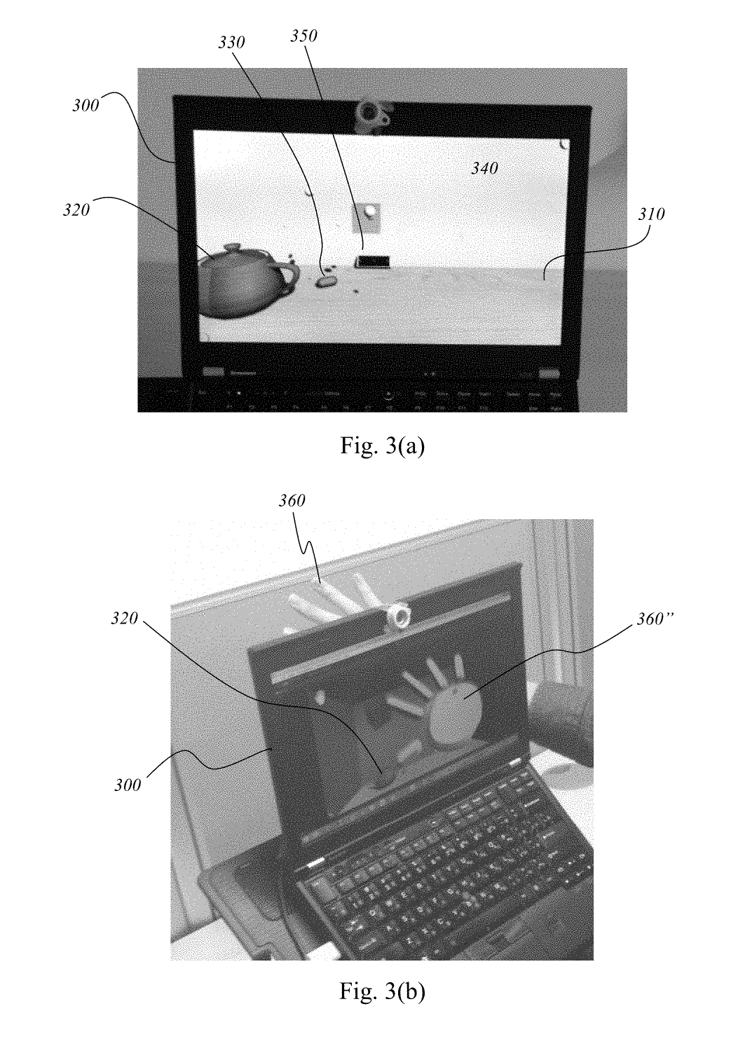

FIGS. 3(a) and 3(b) are images illustrating the actual operating scenario for the three-dimension interactive system in accordance with the present invention. A virtual teapot 320 is placed on a virtual table 310. There is still a miscellaneous virtual item 330 placed on the virtual table 310. The virtual table 310 is placed by the virtual wall 340. A virtual motion sensor 350 is placed on a spot close to the virtual wall 340 on the virtual table 310. The locations where virtual table 310, the virtual wall 340 and the virtual motion sensor 350 are placed are corresponding to where the real table, the real wall and the real motion sensor are placed in the real world.

The user watches and perceives the virtual reality shown in the screen 300. It looks like the virtual teapot 320 is placed behind the screen 300. So the user then gets started to move and stretch the real right hand 360 to try to catch the virtual teapot 320 on the virtual table 310 shown on the screen 300. In order to touch the virtual teapot 320, the user shall move the real right hand 360 to the rear side behind the screen 300. At this time, the real motion sensor behind the screen 300 captures the movements from the real right hand 360 and a virtual right hand 360″ is instantly simulated and shown on the screen 300, in corresponding to the real right hand 360.

The virtual right hand 360″ shown on the screen 300 has a size, a gesture, a location, a posture in proportion, in compliance or in scale with respect to the real right hand 360 comprehensively. Then the user is able to keep moving the real right hand 360 in reference with the virtual contents including the virtual right hand 360″, the virtual table 310 and the virtual wall 340, until the user catches the virtual teapot 320. The real motion sensor behind the screen 300 detects and senses the movements, the postures and the gestures from the real right hand 360. The user can control the virtual right hand 360″ on the screen 300 to touch, to revolve, to spin, to move or to play the virtual teapot 320, through perceiving and watching the virtual right hand 360″ on the screen 300. The system commands and controls the virtual teapot 320 to response the actions and movements from the real right hand 360, so that the user can have a virtual interaction with the virtual teapot 320 by moving the real right hand 360.

For the above-mentioned rear screen three-dimension interactive system, the perspective vision location in the entire virtual reality is not varied or changed in response to the movement of the eyesight or vision by the user. When the user moves, the eyesight changes correspondingly. Therefore, there lacks a space coupling between the perceived visual location and the manipulating model location. As if user moves to somewhere else and changes eyesight, the perspective shown in the virtual reality on the screen is not correspondingly changed. It involves a kinesthetic vision system into the system to couple the perceived visual location and the manipulating model location.

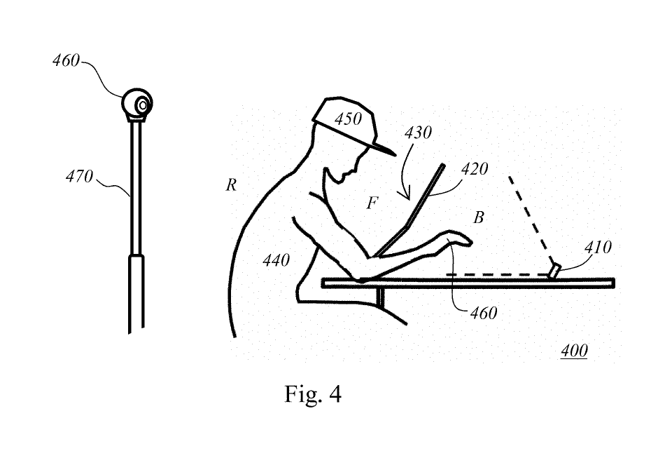

FIG. 4 is a schematic diagram illustrating a rear screen three-dimension kinesthetic interactive system in accordance with the present invention. The kinesthetic interactive system 400 includes a motion sensor 410, a portable computing device 430 with a screen 420, and an image sensor 460. A front side F and a rear side R are used to define a space in front of the screen 420 and a space in back of the screen 420 respectively. The motion sensor 410 is still configured on a spot behind the screen 420 and an image sensor 460 is additionally added into a spot in front of the screen 420. A user 440 who is situated at the front side F is sitting in front of the screen 420 and watching the virtual contents provided and shown on the screen 420. The motion sensor 410 is a sensor capable of sensing, detecting, tracing or recording actions, motions or traces from human's fingers, hands or gestures. The information the motion sensor 410 detected is sent to the portable computing device 430 as inputs. A motion controller produced by Leap Motion, Inc. is adopted as the motion sensor 410.

In order to trace the real eyesight from the user 440 to correspondingly change the perceived visual location and the manipulating model location, the image sensor 460 is thus additionally added into the system and is situated in the front side F and in a back side B in back of the user 440. The image sensor 460 is a webcam camera, a digital camera or a movie camera. The image sensor 460 is configured on a spot behind the head portion of the user 440 by a camera racket 470 so as to have a height close to the eyesight of the user 440. The image sensor 460 keeps a second distance from the screen 420 and a third distance from the user 440. In order to easily identify the eyesight, an eyesight marker made as a hat is wore on the head of the user 440. The changes and movements of the eyesight are correspondingly detected and sensed by tracing the changes and movements of the head of the user 440.

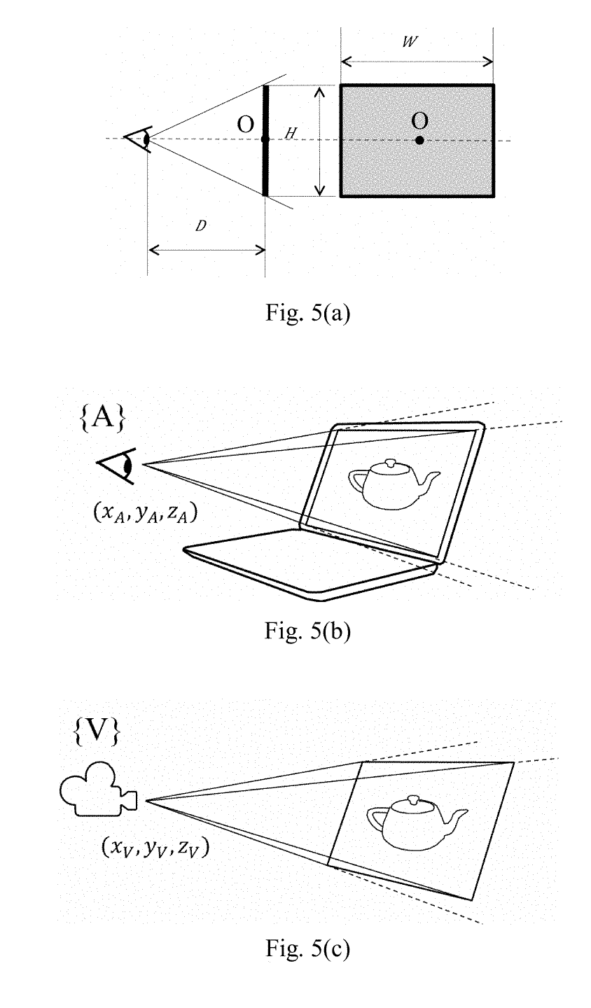

FIGS. 5(a)-5(c) are schematic diagrams illustrating a space coupling relationship used in the kinesthetic interactive system in accordance with the present invention. In order to establish a space coupling based image, the system in the present invention builds an appropriate kinesthetic vision in the virtual reality on the screen through synchronizing both the location in the real vision and the location in the virtual vision. The kinesthetic vision in the virtual reality is capable of demonstrating the space coupling relationship, to cause the user truly perceives the kinesthetic sense in the virtual reality.

The purpose of this part is to present the appropriate virtual scene by synchronizing between real and virtual eyes positions. During the virtual and real eyes moving simultaneously, the relative displacement of viewed articles, so called “motion parallax”, provides a visual depth cue.

As shown in FIGS. 5(a) to 5(c), when the real eyesight the real vision moves, a motion parallax is presented between the real vision and the virtual vision. The geometric relationship between the virtual vision and the real vision are listed as follows:

$$\begin{matrix}{x}_{v} = \frac{{W}_{v}}{{W}_{A}} \cdot {x}_{A} & ( 1 ) \\ {y}_{V} = \frac{{H}_{V}}{{H}_{A}} \cdot {y}_{A} & ( 2 ) \\ {z}_{V} = \frac{{D}_{V}}{{D}_{A}} \cdot {z}_{A} & ( 3 )\end{matrix}$$

x_{V},y_{V},z_{V} are the position of the virtual eyes and x_{A},y_{A},z_{A} are the position of the real eyes. Coordinate origins is at the center of the screen and the near plane. W_{V} is the width of the near plane, and W_{A} is the width of the screen view. H_{V} is the height of the near plane, and H_{A} is the height of the screen view. D_{V} is the distance from of the virtual eye coordinates origin to the near plane center, and D_{A} is the distance from of the real eye coordinates origin to the screen center.

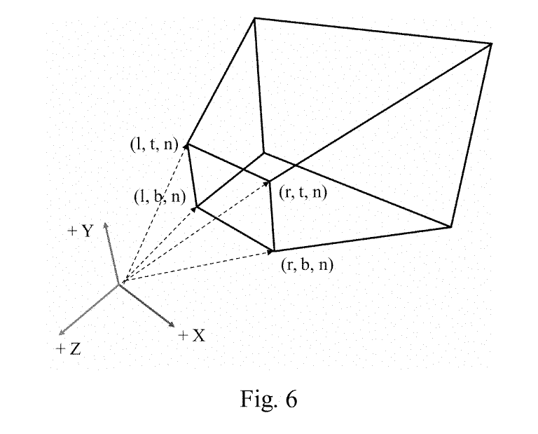

FIG. 6 is a diagram illustrating a geometric relationship between a frustum and a near plane for building a kinesthetic vision in the virtual reality in accordance with the present invention. In order to simulate the shape of real viewing frustum through a virtual frustum, the relative position of the user's eyes to the monitor is needed. In FIG. 6, the parameters r, l, t, b and n are positions parameters of the near plane to the local eye coordination. The parameter f is a distance originated from any point on the near plane to the z axis direction, which is set up to infinity in this embodiment. As the eyes moving, above parameters will be changed and need to be substituted into equation (4) of projection matrix as follows:

$$M = ( \begin{matrix}\frac{2 n}{r - 1} & 0 & \frac{r \vert l}{r - l} & 0 \\ 0 & \frac{2 n}{t - b} & \frac{t + b}{t - b} & 0 \\ 0 & 0 & \frac{- ( f + n )}{f - n} & \frac{- 2 fn}{f - n} \\ 0 & 0 & - 1 & 0\end{matrix} ) \qquad ( 4 )$$

In brief, a realistic environment which is similar with the real environment behind the screen is constructed, and the kinesthetic vision is implemented to provide the correct perspective.

Through the calculation of the above equations (1) to (4), the kinesthetic vision is involved in the three-dimension interactive system, to make the three-dimension interactive system to become a three-dimension kinesthetic interactive system in the present invention. Through operating the rear screen three-dimension kinesthetic interactive system in the present invention, the user can clearly perceives a very keen and sensitive kinesthetic vision presented in the virtual reality shown the screen.

In the implementation, the physical hardware setup is introduced as follows. The laptop computer Lenovo X220 with a 12.5″ monitor, a set of 2-core 2.3 GHz CPU and an Intel HD Graphics 3000 is used. The Logitech webcam are used for mark tracking. The webcam is set up behind users. Users are required to wear a red cap as a head tracking mark. Leap Motion controller is a computer sensor device, detecting the motions of hands, fingers and finger-like tools as input, and the Leap Motion API allow developers to get tracking data for further uses.

For the software, a Unity game engine is chosen to construct the game environment, developed in C#. In addition, an OpenCV library is used to implement the mark tracking function, integrating with Leap Motion API as mentioned earlier.

The present invention builds up a realistic environment which is similar with the real environment behind the screen, and kinesthetic vision is involved in to provide the correct perspective.

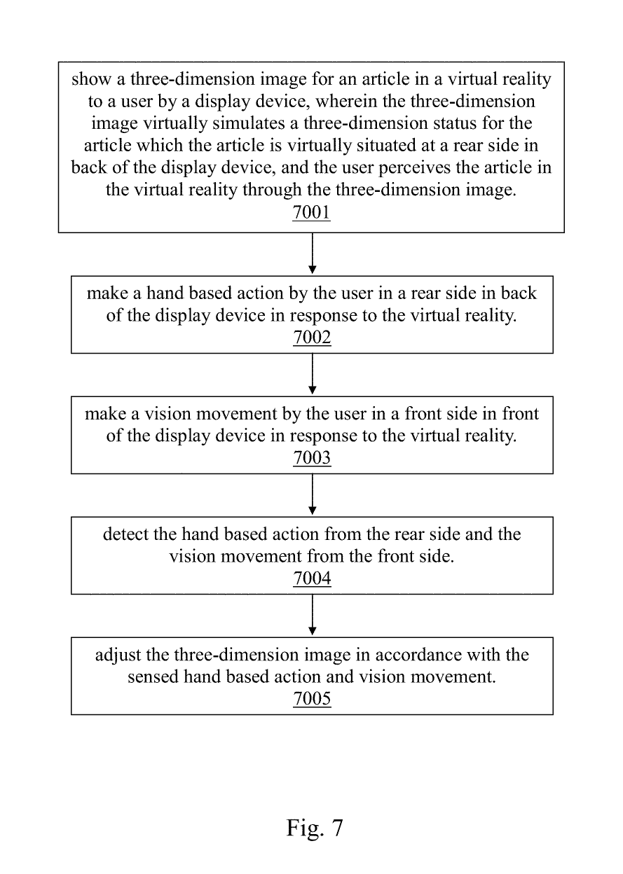

FIG. 7 shows a flow chart for implementing the above rear screen three-dimension kinesthetic interactive method for a virtual reality in accordance with the present invention. Accordingly, it is easily to conclude the following required multiple steps for performing the above rear screen three-dimension kinesthetic interactive method for a virtual reality as correspondingly shown in FIG. 7.

Step 7001: show a three-dimension image for an article in a virtual reality to a user by a display device, wherein the three-dimension image virtually simulates a three-dimension status for the article which the article is virtually situated at a rear side in back of the display device, and the user perceives the article in the virtual reality through the three-dimension image. Step 7002: make a hand based action by the user in a rear side in back of the display device in response to the virtual reality. Step 7003: make a vision movement by the user in a front side in front of the display device in response to the virtual reality. Step 7004: detect the hand based action from the rear side and the vision movement from the front side. Step 7005: adjust the three-dimension image in accordance with the sensed hand based action and vision movement.

To sum up, the present invention develops a novel interactive interface with 3D virtual model, called “VR Glovebox”, which combines a laptop with a motion sense controller to track hands' motion and a webcam to track head motions. Instead of placing the controller in front of the laptop monitor generally, the controller tracks user's hands in “back” of the monitor. The setup couples the actual interactive space with the virtual space. In addition, the webcam detects the position of user's head for the purpose of deciding position of a camera in a virtual world for the kinesthetic vision. With the proposed elements above, the interface brings analogous data from hands to a digital world but remains the fidelity of spatial sense in the real world visually, allowing users to interact with 3D model directly and naturally. To evaluate the design, we conducted the virtual objects moving experiments and the results validate the performance of depth perception in the design.

There are further embodiments provided as follows.

### Embodiment 1

A three-dimension interactive system for a virtual reality includes a computing device; a display device electrically connected with the computing device, facing toward a user, and showing a three-dimension image for an article to the user; an image sensor electrically connected with the computing device, situated at a front side in front of the display device, keeping a second distance from the display device, and sensing a vision movement made by the user who is situated in the front side; and a motion sensor electrically connected with the computing device, situated at a rear side in back of the display device, keeping a first distance from the display device, and sensing a hand based action made by the user in the rear side.

### Embodiment 2

The system as described in Embodiment 1 further includes a vision movement marker configured on the user for the image sensor to detect for sensing the vision movement from the user.

### Embodiment 3

The system as described in Embodiment 1, the user watches the three-dimension image and makes the hand based action and the vision movement in reaction to the article in accordance with the three-dimension image.

### Embodiment 4

The system as described in Embodiment 3, the motion sensor senses the hand based action and sends to the computing device, the image sensor senses the vision movement and sends to the computing device, and the computing device instantly adjust the three-dimension image in accordance with the hand based action and the vision movement, whereby the user is able to experience an interaction with the article virtually.

### Embodiment 5

The system as described in Embodiment 1, the computing device, the display device, the motion sensor, and the image sensor are electrically connected with each other through one of a wireless communication scheme and a wire-based communication scheme.

### Embodiment 6

The system as described in Embodiment 5, the wireless communication scheme is one selected from a Bluetooth communication technology, a Wi-Fi communication technology, a 3G communication technology, a 4G communication technology and a combination thereof.

### Embodiment 7

The system as described in Embodiment 1, the computing device is one selected from a notebook computer, a desktop computer, a tablet computer, a smart phone and a phablet.

### Embodiment 8

The system as described in Embodiment 1, the motion sensor is one selected from an action controller and an infrared ray motion sensor.

### Embodiment 9

The system as described in Embodiment 1, the image sensor is one selected from a webcam camera, a digital camera and a movie camera.

### Embodiment 10

A three-dimension interactive system for a virtual reality includes a computing device; a display device electrically connected with the computing device, facing toward a user, and showing a three-dimension image for an article to the user; and a motion sensor electrically connected with the computing device, situated at a rear side in back of the display device, keeping a first distance from the display device, sensing a hand based action made by the user in the rear side, and sending the hand based action to the computing device, wherein the user makes the hand based action in reaction to the article virtually situated in back of the display device in accordance with the three-dimension image and the computing device instantly adjusts the three-dimension image in accordance with the hand based action.

### Embodiment 11

The system as described in Embodiment 10 further includes an image sensor electrically connected with the computing device, situated at a front side in front of the display device, keeping a second distance from the display device, sensing a vision movement made by the user who is situated in the front side, and sending the vision movement to the computing device.

### Embodiment 12

A three-dimension interactive method for a virtual reality includes showing a three-dimension image for an article in a virtual reality to a user by a display device, wherein the three-dimension image virtually simulates a three-dimension status for the article which the article is virtually situated at a rear side in back of the display device, and the user perceives the article in the virtual reality through the three-dimension image; making a hand based action by the user in a rear side in back of the display device; sensing the hand based action from the rear side; and adjusting the three-dimension image in accordance with the sensed hand based action.

### Embodiment 13

The method as described in Embodiment 12 further includes making a vision movement by the user in a front side in front of the display device; sensing the vision movement from the front side; and adjusting the three-dimension image in accordance with the sensed hand based action and vision movement.

### Embodiment 14

The method as described in Embodiment 12, the user makes the hand based action and the vision movement in reaction to the article in accordance with the three-dimension image, and the three-dimension image is instantly adjusted in accordance with the hand based action and the vision movement, whereby the user is able to experience an interaction with the article virtually.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

1. (canceled)

2. (canceled)

3. A three-dimension interactive system for a virtual reality, comprising:
a computing device;
a display device electrically connected with the computing device, facing toward a user, and showing a three-dimension image for an article to the user;
an image sensor electrically connected with the computing device, situated at a front side in front of the display device, keeping a second distance from the display device, and sensing a vision movement made by the user who is situated in the front side; and
a motion sensor electrically connected with the computing device, situated at a rear side in back of the display device, keeping a first distance from the display device, and sensing a hand based action made by the user in the rear side.

4. The system as claimed in claim 3 further comprising:
a vision movement marker configured on the user for the image sensor to detect for sensing the vision movement from the user.

5. The system as claimed in claim 3, wherein the user watches the three-dimension image and makes the hand based action and the vision movement in reaction to the article in accordance with the three-dimension image.

6. The system as claimed in claim 5, wherein the motion sensor senses the hand based action and sends to the computing device, the image sensor senses the vision movement and sends to the computing device, and the computing device instantly adjust the three-dimension image in accordance with the hand based action and the vision movement, whereby the user is able to experience an interaction with the article virtually.

7. The system as claimed in claim 3, wherein the computing device, the display device, the motion sensor, and the image sensor are electrically connected with each other through one of a wireless communication scheme and a wire-based communication scheme,

8. The system as claimed in claim 7, wherein the wireless communication scheme is one selected from a Bluetooth communication technology, a Wi-Fi communication technology, a 3G communication technology, a 4G communication technology and a combination thereof.

9. The system as claimed in claim 3, wherein the computing device is one selected from a notebook computer, a desktop computer, a tablet computer, a smart phone and a phablet.

10. The system as claimed in claim 3, wherein the motion sensor is one selected from an action controller and an infrared ray motion sensor.

11. The system as claimed in claim 3, wherein the image sensor is one selected from a webcam camera, a digital camera and a movie camera.

12. A three-dimension interactive system for a virtual reality, comprising:
a computing device;
a display device electrically connected with the computing device, facing toward a user, and showing a three-dimension image for an article to the user; and
a motion sensor electrically connected with the computing device, situated at a rear side in back of the display device, keeping a first distance from the display device, sensing a hand based action made by the user in the rear side, and sending the hand based action to the computing device,
wherein the user makes the hand based action in reaction to the article virtually situated in back of the display device in accordance with the three-dimension image and the computing device instantly adjusts the three-dimension image in accordance with the hand based action.

13. The system as claimed in claim 12, further comprising:
an image sensor electrically connected with the computing device, situated at a front side in front of the display device, keeping a second distance from the display device, sensing a vision movement made by the user who is situated in the front side, and sending the vision movement to the computing device.

14. A three-dimension interactive method for a virtual reality, comprising:
showing a three-dimension image for an article in a virtual reality to a user by a display device, wherein the three-dimension image virtually simulates a three-dimension status for the article which the article is virtually situated at a rear side in back of the display device, and the user perceives the article in the virtual reality through the three-dimension image;
making a hand based action by the user in a rear side in back of the display device;
sensing the hand based action from the rear side; and
adjusting the three-dimension image in accordance with the sensed hand based action.

15. The method as claimed in claim 14, further comprising:
making a vision movement by the user in a front side in front of the display device;
sensing the vision movement from the front side; and
adjusting the three-dimension image in accordance with the sensed hand based action and vision movement.

16. The method as claimed in claim 14, wherein the user makes the hand based action and the vision movement in reaction to the article in accordance with the three-dimension image, and the three-dimension image is instantly adjusted in accordance with the hand based action and the vision movement, whereby the user is able to experience an interaction with the article virtually.
